(19) United States
(12) Patent Application Publication
(10) Pub. No.: US 2018/0323846 A1
(43) Pub. Date: Nov. 8, 2018

(54) METHODS AND APPARATUS FOR ACQUIRING CHANNEL STATE INFORMATION WITH CHANNEL RECIPROCITY

(71) Applicant: MediaTek Inc., Hsin-Chu (TW)

(72) Inventors: Lung-Sheng Tsai, Hsin-Chu (TW); Weidong Yang, San Jose, CA (US)

(73) Assignee: MediaTek Inc., Hsin-Chu (TW)

(21) Appl. No.: 15/971,442

(22) Filed: May 4, 2018

Related U.S. Application Data
(60) Provisional application No. 62/520,617, filed on Jun. 16, 2017.
(60) Provisional application No. 62/501,922, filed on May 5, 2017.

(51) Int. Cl. H04B 7/06; H04W 8/22; H04L 25/02; H04B 7/0456

(52) U.S. Cl. CPC H04B 7/0617; H04W 8/22; H04B 7/0626; H04B 7/0456; H04L 25/0202

(57) ABSTRACT

The techniques described herein relate to methods, apparatus, and computer readable media configured to provide for wireless techniques related to channel reciprocity. A channel estimation process between a mobile device and a base station is configured. The channel estimation process includes estimating a set of channel characteristics for an uplink direction of the wireless communication channel based on signals transmitted by the mobile device over the first set of antennas, and receiving a report associated with a set of channel characteristics for a downlink direction of the wireless communication channel from the mobile device, wherein the mobile device generates the report based on the estimated set of channel characteristics for the downlink direction of the wireless communication channel corresponding to the first set of antennas.

### RELATED APPLICATIONS

This Application claims priority under 35 U.S.C. § 119(e) to U.S. Provisional Application Ser. No. 62/520,617, filed Jun. 16, 2017, entitled “RECIPROCITY BASED CSI ACQUISITION” and U.S. Provisional Application Ser. No. 62/501,922, filed May 5, 2017, entitled “CSI ACQUISITION WITH PARTIAL CHANNEL RECIPROCITY”, which are herein incorporated by reference in their entirety.

### TECHNICAL FIELD

The techniques described herein relate generally to channel state information acquisition with channel reciprocity.

### BACKGROUND OF INVENTION

Wireless communications systems, such as Long Term Evolution (LTE) systems and 5G New Radio (NR) systems, can support different types of wireless operation. For example, LTE can support both frequency-division duplex (FDD) and time-division duplex (TDD) access. When using TDD, the uplink (UL) transmissions from the UE to the base station and the downlink (DL) transmissions from the base station to the UE can share the same channel. Since the uplink and downlink transmissions share the same channel, if the channel state of one direction can be estimated, then the other direction can be approximated based on the estimated direction. For example, the channel state for both the downlink and uplink can be obtained through uplink channel estimation (e.g., assuming that the channel is reciprocal and static over a few packet transmissions).

### SUMMARY OF INVENTION

In accordance with the disclosed subject matter, apparatus, systems, and methods are provided for improved technologies for channel reciprocity.

Some embodiments relate to a computerized method for configuring a base station and a mobile device to estimate channel characteristics of a wireless communication channel. The method includes determining a mobile device is configured to use a first set of antennas to transmit signals and a second set of antennas to receive signals, wherein the first set of antennas is part of the second set of antennas, configuring a channel estimation process between the mobile device and a base station such that the mobile device estimates a set of channel characteristics for a downlink direction of the wireless communication channel corresponding to the first set of antennas, estimating a set of channel characteristics for an uplink direction of the wireless communication channel based on signals transmitted by the mobile device over the first set of antennas, and receiving a report associated with the set of channel characteristics for the downlink direction of the wireless communication channel from the mobile device, wherein the mobile device generates the report based on the estimated set of channel characteristics for the downlink direction of the wireless communication channel corresponding to the first set of antennas.

In some examples, the report comprises an estimated channel quality, an estimated noise quality, or both.

In some examples, estimating the set of channel characteristics of the uplink direction includes estimating the uplink direction based on sounding reference signals (SRSs) sent by the mobile device to the base station over the first set of antennas, and receiving the report associated with the set of channel characteristics for the downlink direction of the wireless communication channel includes receiving channel state information (CSI) generated by the mobile device assuming the first set of antennas are receive antennas.

In some examples, configuring the channel estimation process between the base station and the mobile device includes configuring the mobile device to use the first set of antennas to send the SRSs, and generate the CSI feedback associated with the first set of antennas.

In some examples, configuring the channel estimation process between the base station and the mobile device includes signaling between the mobile device and the base station to configure the channel estimation process, accessing a predetermined rule that configures the channel estimation process, or both.

Some embodiments relate to a computerized method for performing channel estimation of a wireless communication channel. The method includes constraining beamforming implemented by the base station for the wireless communication channel, comprising restricting the base station to use a set of precoders for a set of frequency sets, wherein the base station is restricted to use each precoder in the set of precoders for one associated frequency set from the set of frequency sets to perform beamforming, and transmitting to the mobile device data indicative of the constrained beamforming implemented by the base station.

In some examples, transmitting to the mobile device data indicative of the constrained beamforming implemented by the base station includes configuring the mobile device to assume that one precoder from the set of precoders over its one associated frequency set for performing channel estimation of the wireless communication channel.

In some examples, restricting the base station to use each precoder over an associated frequency set includes restricting the base station to use a precoder for a predetermined set of units in frequency domain. The predetermined set of units can include a unit selected from the group consisting of a set of adjacent resource blocks, a set of adjacent subcarriers, and a set of adjacent frequency bands.

Some embodiments relate to a base station comprising a processor in communication with memory, the processor being configured to execute instructions stored in the memory that cause the processor to configure a channel estimation process between a mobile device and the base station such that the mobile device estimates a set of channel characteristics for a downlink direction of the wireless communication channel corresponding to a first set of antennas, wherein the mobile device is configured to use the first set of antennas to transmit signals and a second set of antennas to receive signals, wherein the first set of antennas is part of the second set of antennas, estimate a set of channel characteristics for an uplink direction of the wireless communication channel based on signals transmitted by the mobile device over the first set of antennas, and receive a report associated with the set of channel characteristics for the downlink direction of the wireless communication channel from the mobile device, wherein the mobile device generates the report based on the estimated set of channel characteristics for the downlink direction of the wireless communication channel corresponding to the first set of antennas.

In some examples, the report includes an estimated channel quality, an estimated noise quality, or both.

In some examples, estimating the set of channel characteristics of the uplink direction includes estimating the uplink direction based on sounding reference signals (SRSs) sent by the mobile device to the base station over the first set of antennas, and receiving the report associated with the set of channel characteristics for the downlink direction of the wireless communication channel includes receiving channel state information (CSI) generated by the mobile device assuming the first set of antennas are receive antennas.

Some embodiments relate to a mobile device. The mobile device includes a plurality of antennas, wherein a first set of the plurality of antennas are used to transmit signals and a second set of the plurality of antennas are used to receive signals, wherein the first set of the plurality of antennas is part of the second set of the plurality of antennas. The mobile device includes a processor in communication with memory, the processor being configured to execute instructions stored in the memory that cause the processor to transmit signals to a base station over the first set of the plurality of antennas, estimate a set of channel characteristics for a downlink direction of the wireless communication channel from the base station, and generate a report associated with a set of channel characteristics for a downlink direction of the wireless communication channel based on the estimated set of channel characteristics for the downlink direction of the wireless communication channel corresponding to the first set of the plurality of antennas.

In some examples, the report comprises an estimated channel quality, an estimated noise quality, or both.

In some examples, transmitting the signals to the base station over the first set of the plurality of antennas includes transmitting sounding reference signals (SRSs) to the base station over the first set of antennas, and generating the report includes generating channel state information (CSI) based on the first set of antennas being receive antennas.

Some embodiments relate to a computerized method executed by a base station, including configuring a channel estimation process between a mobile device and the base station such that the mobile device estimates a set of channel characteristics for a downlink direction of the wireless communication channel corresponding to a first set of antennas, wherein the mobile device is configured to use the first set of antennas to transmit signals and a second set of antennas to receive signals, wherein the first set of antennas is part of the second set of antennas, estimating a set of channel characteristics for an uplink direction of the wireless communication channel based on signals transmitted by the mobile device over the first set of antennas, and receiving a report associated with the set of channel characteristics for the downlink direction of the wireless communication channel from the mobile device, wherein the mobile device generates the report based on the estimated set of channel characteristics for the downlink direction of the wireless communication channel corresponding to the first set of antennas.

Some embodiments relate to a computerized method for a mobile device, including transmitting signals to a base station over a first set of a plurality of antennas, wherein the first set of the plurality of antennas are used to transmit signals and a second set of the plurality of antennas are used to receive signals, wherein the first set of the plurality of antennas is part of the second set of the plurality of antennas, estimating a set of channel characteristics for an downlink direction of the wireless communication channel, based on the signals received over the second set of the plurality of antennas, and generating a report associated with a set of channel characteristics for a downlink direction of the wireless communication channel based on the estimated set of channel characteristics for the downlink direction of the wireless communication channel corresponding to the first set of the plurality of antennas.

Some embodiments relate to a mobile device configured to perform channel estimation of a wireless communication channel between the mobile device and the base station. The mobile device includes a transceiver comprising a set of antennas. The mobile device also includes a processor in communication with memory and the transceiver, the processor being configured to execute instructions stored in the memory that cause the processor to receive a signal indicative of a constraining beamforming implemented by the base station for the wireless communication channel, the signal indicative of the base station being restricted to use a set of precoders for a set of frequency sets, wherein the base station is restricted to use each precoder in the set of precoders for one associated frequency set from the set of frequency sets to perform beamforming.

In some examples, the processor is further configured to perform channel estimation using one precoder from the set of precoders for a predetermined set of units in frequency domain. The predetermined set of units can include a unit selected from the group consisting of a set of adjacent resource blocks, a set of adjacent subcarriers, and a set of adjacent frequency bands.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows an exemplary wireless communication system, according to some embodiments.

FIG. 2 shows mathematical representations of signals for the downlink and uplink portions of a channel, according to some examples.

FIG. 3 shows a signal model for a user equipment's (UE's) processing to derive channel state information, according to some embodiments.

FIG. 4 shows an exemplary signal model or deriving non-PMI feedback for partial channel reciprocity, according to some embodiments.

FIG. 5 is an exemplary computerized method for partial channel reciprocity, according to some embodiments.

FIG. 6 shows an exemplary method for facilitating reciprocity-based channel estimation, according to some embodiments.

### DETAILED DESCRIPTION OF INVENTION

The techniques discussed herein can be used to support channel state information (CSI) acquisition with channel reciprocity. The inventors have determined that channel reciprocity (e.g., where one direction of a channel can be estimated based on the other direction of the channel) is not adequately supported by existing wireless systems for circumstances where only partial channel reciprocity exists (e.g., a UE can only transmit on a subset of its available antennas). For example, partial channel reciprocity may not be supported at all, or where it is supported, it may not support certain hardware and/or software configurations of the associated devices. As discussed further herein, the inventors have developed techniques to facilitate partial channel reciprocity, such as by using subchannels that exhibit full channel reciprocity. The inventors have developed signaling and/or rules to facilitate partial channel reciprocity.

The inventors have also determined that existing reciprocity-based channel estimation techniques can be negatively affected by beamforming. For example, beamforming can cause measurement errors and/or complicate the channel estimation process when using partial or full channel reciprocity. As discussed further herein, the inventors have developed techniques for providing CSI feedback with channel reciprocity. For example, the techniques disclosed herein can reduce the overhead required for CSI signaling, can restrict the precoder to improve channel estimation, and/or can configure codebooks for channel configurations not yet supported by existing wireless systems and standards.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

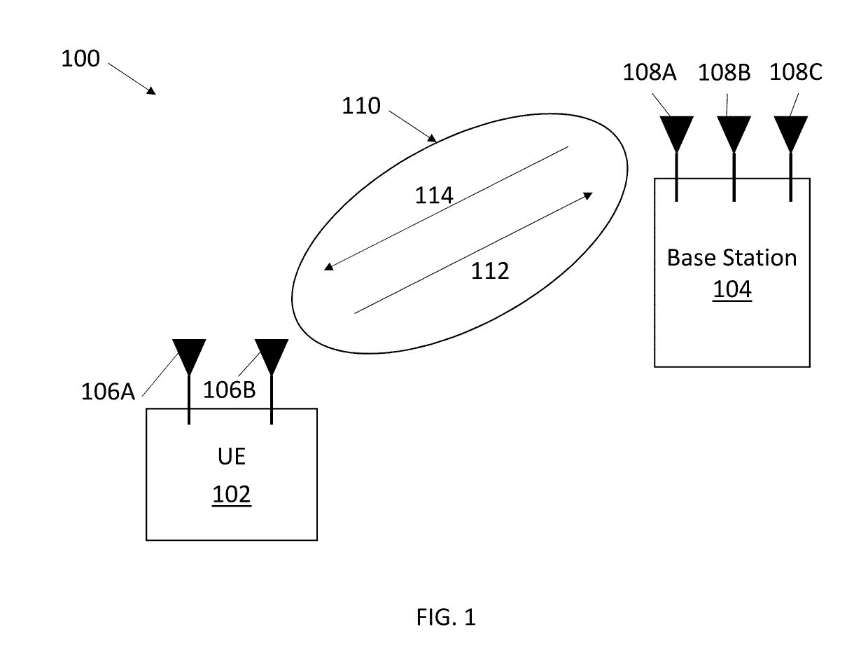

FIG. 1 shows an exemplary wireless communication system 100 (e.g., a 3G, 4G, and/or a 5G New Radio (NR) system), according to some embodiments. The wireless communication system 100 includes a mobile device, or UE, 102 and a base station, or BS, 104. A UE 102 can be, for example, a cell phone, a smart phone, a laptop, and/or any other device configured to wirelessly communicate with the BS 104. The BS 104 can be, for example, a base station (e.g., a cellular base station), such as an evolved Node B (eNB), a next Generation Node B (gNB), and/or the like. As shown in the example of FIG. 1, the UE 102 has two antennas, antennas 106A and 106B, collectively referred to herein as antennas 106. The BS 104 has three antennas, antennas 108A, 108B and 108C, collectively referred to herein as antennas 108. The UE 102 and BS 104 communicate over a wireless communications channel 110. Transmissions from the UE 102 to the BS 104 are often referred to as uplink communications, shown as 112. Transmissions from the BS 104 to the UE 102 are often referred to as downlink communications, shown as 114. The configuration shown in FIG. 1 is a simplified example that is not intended to be limiting. For example, the UE 102 and/or BS 104 may have different numbers of antennas. As another example, the UE 102 and the BS 104 may communicate over a number of different frequencies and/or channels, which is not shown in FIG. 1. Additionally, the BS 104 is typically in communication with a plurality of UEs, although this is not shown in FIG. 1 for simplicity.

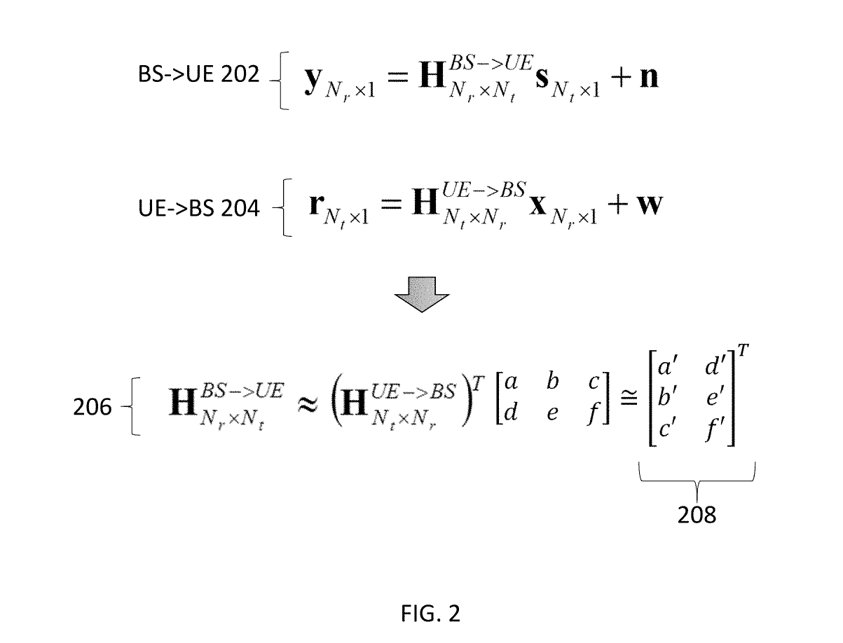

For full channel reciprocity, channel estimation can be acquired at the base station 104 side. Channel reciprocity can, for example, ease the burden of feedback overhead, overhead of downlink reference signals (RSs), and/or the like, such as for scenarios with a large number of transmission antennas. FIG. 2 shows mathematical representations of signals for the downlink and uplink portions of a channel, according to some examples. The formula 202 shows the signal formulation for a received signal in the downlink, where where H_{N}_{ᵣ}_{×N}_{ₜ}^{BS->UE} is the channel of the link from the BS to the UE, s_{N}_{ₜ}_{×1} is a reference signal and/or data signal transmitted by the BS with Nₜ transmit antennas, and n_{N}_{ᵣ}_{×1} is the noise signal received at the UE with Nᵣ receive antennas. In a FDD system, the network is often configured to transmit reference signals (RSs) over all Nₜ ports, so that the UE can estimate the channel H_{N}_{ᵣ}_{×N}_{ₜ}^{BS->UE}. For example, the UE can estimate the channel/noise quality using the RSs. Based on the channel estimate, the UE can derive CSI information and feed that information back to the network. The CSI information can include, for example, precoding directions (PMI), rank, and channel quality indicator (CQI), which reflects the signal to noise ratio for the BS-to-UE link. In a TDD system, the UE may send sounding reference signals (SRSs) so that the BS can estimate channel of the UE-to-BS link.

The formula 204 shows the signal formulation for a received signal in the uplink. As shown, formula 204 assumes that the number of antenna ports used to send SRS is the same as the number of receive antenna ports in downlink, Nᵣ. The BS may estimate the channel link from the UE to the BS H_{N}_{ₜ}_{×N}_{ᵣ}^{UE->BS} based on r_{N}_{ₜ}_{×1} and x_{N}_{ᵣ}_{×1}. The channel reciprocity can be exploited by assuming H_{N}_{ᵣ}_{×N}_{ₜ}^{BS->UE}≈(H_{N}_{ₜ}_{×N}_{ᵣ}^{UE->BS})^{T} (e.g., if the transmit and receive circuits match). As a result, H_{N}_{ₜ}_{×N}_{ᵣ}^{US->BS} can be utilized for downlink link adaptation.

Even if full channel reciprocity is available, the BS typically needs information related to the noise level at UE for adaquate link adapatiaon in DL. In LTE, for example, additional CQI feedback is used in a TDD system so that the BS can estimate the noise power at the UE side. For example, the UE can assume a rank-1 precoder p, and/or use a predefined transmssion scheme (e.g., space frequency block coding (SFBC) can be used in LTE) to derive a CQI to report to the network. If the CQI feedback is derived without suggesting a best precoder from the UE's respective, the feedback is often referred to as non-PMI feedback. The reported CQI approximately implies the signal-to-noise ratio at UE side. Then the BS can estimate the noise power level experienced at the UE side based on the CQI and an estimation on H_{N}_{ₜ}_{×N}_{ᵣ}^{UE->BS} conditioned on applying the predefined rank-1 precoder p (or SFBC).

Equation 206 in FIG. 2 shows a formula relating the downlink channel from the BS to the UE H_{N}_{ᵣ}_{×N}_{ₜ}^{BS->UE} to the uplink channel from the UE to the BS H_{N}_{ₜ}_{×N}_{ᵣ}^{UE->BS}. The formula includes a DL channel matrix where the top row (a b c) represents the channel between the three BS transmit antennas and one of the UE receive antennas, and the second row (d e f) represents the channel between the three BS transmit antennas and the other UE receive antenna. It also includes a UL channel matrix 208 where the first column composed by a′, b′, and c′ represents the channel between one of the UE transmit antennas and three BS receive antennas, and the second column composed by d′, e′, and f′ represents the channel between another UE transmit antenna and three BS receive antennas. T indicates a transpose matrix operation (e.g., in this example, to reshape the matrix with 3 rows and 2 columns to a matrix with 2 columns and 3 rows). With ideal channel reciporcity (or full channel channel reciprocity), we may assume Equation 206 holds. In other words, the DL channel can be approximated by the estimation of UL channel.

In some embodiments, only partial channel reciprocity can be achieved. For example, it is possible that transmit (Tx) port number is less than receive (Rx) port number at the UE, such that not all receive antennas at the UE are used to transmit SRS. For example, if a UE has two transmit antennas and the BS has three receive antennas, then there are six channel elements, as shown a-fin formula 206. But if there is only partial channel reciprocity, the UE may only be able to transmit on one antenna (e.g., while still using both antennas for receiving), and therefore only part of the channel matrix can be estimated (e.g., just a-c).

Partial channel reciprocity may not be supported by existing schemes and/or network setups. For example, a UE may be configured to always assume that full-channel information is available to derive CQI. Such CQI based on full-channel information cannot be used at the BS (e.g., gNB) side to derive the noise power if the gNB cannot obtain full channel information. For example, while non-PMI feedback has been proposed, some wireless standards (e.g., 5G NR) may assume that full channel reciprocity is available. Under this assumption, the precoder for the downlink transmission can be derived from the estimation of H_{N}_{ₜ}_{×N}_{ᵣ}^{UE->BS}. As a result, the UE does not need to feed PMI back to the network to save feedback overhead. CQI may still be needed, such that the BS can estimate the noise/interference level experienced at UE side. In LTE, for example, non-PMI feedback can cause the UE to report only RI and CQI based on beamformed or non-beamformed CSI-RS (Channel State Information Reference Signal). The precoder applied on the beamformed CSI-RS can be derived from the estimation of H_{N}_{ₜ}_{×N}_{ᵣ}^{UE->BS}.

However, non-PMI feedback has not been provide for in the partial channel reciprocity case. The downlink channel H_{N}_{ᵣ}_{×N}_{ₜ}^{BS->UE} can be denoted by

$$[ \begin{matrix}{H}_{1 {N}_{r} / 2 \times {N}_{t}} \\ {H}_{2 {N}_{r} / 2 \times {N}_{t}}\end{matrix} ] .$$

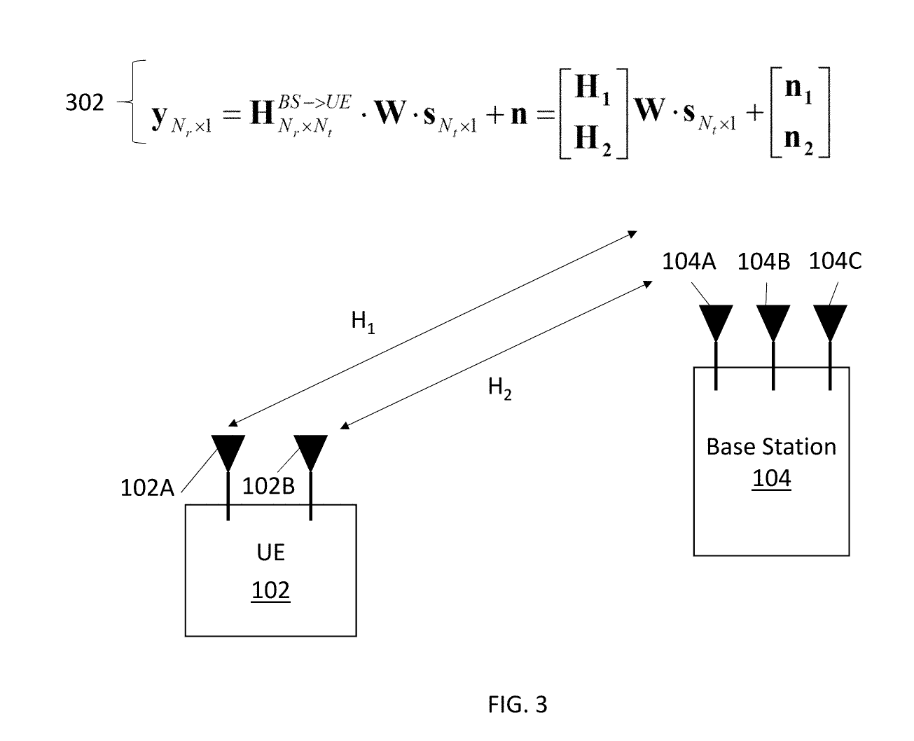

Assuming half of the antennas of a UE are used to transmit SRS, the BS can only have an estimation on H₁ but not the whole H_{N}_{ᵣ}_{×N}_{ₜ}^{BS->UE} Under the framework of non-PMI feedback, the UE derives CQI/RI feedback, and the BS knows what transmission scheme and precoding method are used for the UE that is deriving the CQI/RI feedback. FIG. 3 shows a signal model 302 for a UE's processing to derive CQI/RI, according to some embodiments. In the signal model 302, the matrix W captures the precoding of the beamformed CSI-RS and the matrix W is an identity matrix if the CSI-RS is non-beamformed CSI-RS. As shown in FIG. 3, H₁ represents the portion of the channel matrix associated with antenna 102A (e.g., a-c in equation 206 in FIG. 2), and H₂ represents the portion of the channel matrix associated with antenna 102B (e.g., d-f in equation 206 in FIG. 2). Thus, the non-PMI feedback does not provide sufficient information to let the BS derive the noise level at UE side for partial channel reciprocity. For example, the information of H₂ is completely missing at the BS, while the CQI is derived based on

$$[ \begin{matrix}{H}_{1} \\ {H}_{2}\end{matrix} ] .$$

Thus, using such techniques does not support non-PMI feedback under scenarios with partial channel reciprocity.

As another example, when only partial channel reciprocity is available, some techniques propose obtaining the missing path (e.g., d-f) by using SRS switching to obtain full channel information by using multiple SRS transmission instants. For example, if a UE has two transmit antennas and can use both antennas to transmit at different times (but not at the same time), the UE can be configured to transmit training signals using the first antenna (e.g., to estimate a-c) at a first time instance, and then at the next time instance the UE can use the second antenna to transmit training signals to estimate the second row (e.g., to estimate d-f). Non-PMI CSI feedback can be used along with SRS switching. Techniques that use SRS switching can take into account practical impairments in the implementation (e.g., PLL accuracy, insertion loss, power imbalance, etc.). However, the UE may not be able to support such antenna switching (e.g., some UEs may only support single antenna transmissions on just one antenna, and not have the capability to implement SRS switching even if the UE has two antennas).

The techniques discussed herein can be used to perform channel estimation when only partial channel reciprocity is available (e.g., where a UE only has a reduced set of antennas that it can use to transmit training sequences). The techniques can extend channel reciprocity schemes discussed herein (e.g., non-PMI feedback and/or SRS switching) to partial channel reciprocity scenarios. To allow for channel estimation with only a limited set of data that can be obtained about the channel, some signaling and/or predefined rules can be used to configure the BS and/or the UE. For example, the BS and UE can be configured to know which transmit antenna ports are sending SRS, which receive antenna ports are receiving reference signals to derive CQI, and/or the like.

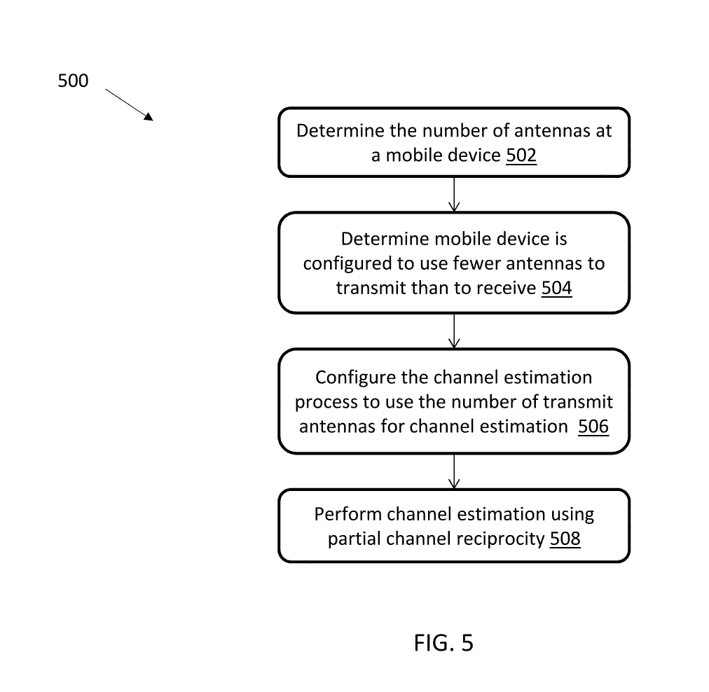

FIG. 5 is an exemplary computerized method 500 for partial channel reciprocity, according to some embodiments. Aspects of method 500 can be implemented by the UE and/or the BS (e.g., the UE 102 and/or the BS 104 in FIG. 1), and therefore method 500 will generally be described in terms of the wireless communication system (e.g., the wireless communication system 100 shown in FIG. 1). At step 502, the system determines the number of antennas at a mobile device. At step 504, the system determines the mobile device is configured to use fewer than the total number of available antennas to transmit a signal (e.g., SRS). The mobile device may still be able to use the full number of available antennas to receive a signal. At step 506, the system configures the channel estimation process between the mobile device and the base station to allow the base station to use partial channel reciprocity to estimate a set of channel characteristics of the wireless communication channel between the mobile device and the base station using the available, reduced set of antennas. At step 508, the system estimates a set of channel characteristics (e.g., an estimated channel quality, an estimated noise quality, and/or the like) of the wireless communication channel using partial channel reciprocity. This can include, for example, estimating a first subset of channel characteristics of the set of channel characteristics for a first direction of the wireless communication channel (e.g., the uplink) based on the configuration in step 506. The system can use the first subset of channel characteristics to estimate the remaining channel characteristics of the second direction (e.g., the downlink) of the wireless communication channel.

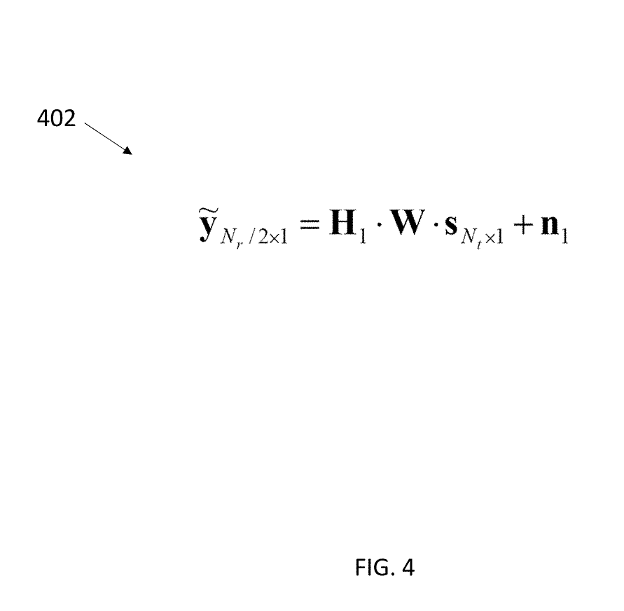

For example, a UE can be configured to report CQI/RI based on a subchannel (e.g., H₁ or H₂) where full-channel reciprocity still holds. FIG. 4 shows an exemplary signal model 402 for deriving non-PMI feedback for partial channel reciprocity, according to some embodiments. In the signal model 402, the UE can derive non-PMI feedback based on H₁ only. This is shown for exemplary purposes, since, for example, H₂ could be used instead of H₁ if H₂ is available, and/or the like. As a result, the mismatch of required information between the BS side and the UE side to derive CQI (e.g., needing both H₁ and H₂) can be avoided by just using the subchannel H₁ in this example. Such feedback can be sufficiently reliable for the BS to derive the experienced interference level (e.g., n₁) at least for part of the receive antennas, since H₁ and W can all be known at the BS. The BS may also be configured to assume that the noise level at each receive antenna at the UE is similar.

Configuring the wireless system to use non-PMI feedback for partial channel reciprocity can include coordinating the BS and the UE to operate in accordance with the available antennas, the data that can be generated using the available antennas, and/or the like. For example, partial channel reciprocity can be implemented by establishing a correspondence between the transmit and receive ports such that “full” channel reciprocity can be configured for one or more subchannels. High-layer configuration signaling and/or rules can be used to configure the BS and/or the UE with a CSI report suitable for utilizing partial channel reciprocity. For example, by network, a UE can be configured to derive a CSI report on subchannels associated with only part of receive antennas, such as the antennas for SRS transmission. The network can configure the UE to feedback such a CSI report periodically and/or aperiodically by dynamic triggering.

In some embodiments, a UE can support SRS switching. In such embodiments, a UE may be configured with time-frequency resources for SRS transmission, and each time-frequency resource can be associated with part of the transmission antenna ports capable of SRS transmission. For SRS switching, the configured time-frequency resources are typically not overlapped in time domain. For example, a UE may send SRS using the first Nᵣ/2 antenna ports in one subframe and send SRS using the remaining Nᵣ/2 antenna ports at another subframe. A BS then can estimate H₁ and H₂ respectively. However, if non-PMI feedback is used, the reported CQI is derived based on

$$[ \begin{matrix}{H}_{1} \\ {H}_{2}\end{matrix} ] .$$

While the BS can acquire the estimation of H₁ and H₂, denoted by Ĥ₁ and Ĥ₂, a co-phasing factor e^{jϕ} may still missing to approximate H_{N}_{ᵣ}_{×N}_{ₜ}^{BS->UE} by

$$[ \begin{matrix}{\hat{H}}_{1} \\ {e}^{j φ} {\hat{H}}_{2}\end{matrix} ] .$$

The co-phasing factor e^{jϕ} may be used, for example, because Ĥ₁ and Ĥ₂ are not estimated at the same time and/or are not obtained coherently. The BS's estimation on UE's noise level based on the non-PMI feedback CQI, Ĥ₁ and Ĥ₂ may not be accurate due to the uncertainty of e^{jϕ}.

In embodiments where SRS switching is available, the techniques disclosed herein can configure a UE to report CQI/RI based on the subchannel where full-channel reciprocity still holds for particular timeframe(s). For example, the system can be configured to derive two non-PMI feedback with CQI₁ and CQI₂. CQI₁ can be derived according to H₁ (e.g., at first time(s)), and CQI₂ can be derived according to H₂ (e.g., at different time(s)). Signaling and/or predefined rules can be used to configure the BS and UE (e.g., as discussed above, such as by dynamic triggering). For example, the BS and UE can be configured to set the transmit antenna ports sending SRS, and the receive antenna ports receiving reference signals to derive CQIₓ. Thus, as discussed herein, in some embodiments additional configuration can be performed (e.g., on the top of legacy non-PMI feedback), such as by using signaling and/or predefined rules, to configure the BS and UE so that each can determine which transmit antenna ports will send SRSs and which receive antenna ports will receive reference signals to derive CQI.

Some wireless communication protocols use beamforming (e.g., at the BS) to shape the overall antenna beam in the direction of a target receiver (e.g., the UI). Beamforming can, for example, increase the signal strength at the receiver. Some beamforming techniques use a precoding vector, or precoder, in the spatial beam to adjust weights of the signals to be transmitted, which can adjust the phase and/or amplitude of the signals to be transmitted by different antennas. In some embodiments, the network determines the precoder that is used to form the directional beam to the UE. Channel reciprocity can be utilized to derive a precoder to form spatial beams. If channel reciprocity is perfect, a BS can optimize the beamforming precoder for each subcarrier because the BS can obtain the channel response of DL channel via the measurement of SRS transmitted by UE on each subcarrier. In some embodiments, the same precoder can be adopted over several adjacent subcarriers, e.g., over each physical resource block (PRB) or each subband, which is composed of multiple PRBs. Therefore, with the aid of channel reciprocity, for a BS transmitting beamformed CSI-RS or beamformed data signals, the precoder used for the CSI-RS and/or data signals in each physical resource block (PRB)/subband could vary from PRB to PRB, in contrast to using the same precoder over the whole band. However, it can be difficult to perform channel estimation when beamforming is frequency-selective. For example, since the precoder can change for each PRB/subband, when the BS applies different precoders, the UE may have trouble performing channel estimation because it can't assume that the channel after beamforming is continuous along the frequency domain (e.g., since the precoders for the CSI-RS can vary along the frequency domain). Since the beam direction applied by network can vary along the frequency band (e.g., since the precoder varies), a UE may not be able to assume that the channel after beamforming is contiguous along the frequency band. For example, at the UE side, the varying precoders can cause the UE to estimate channel coefficients for each subcarrier/PRB independently, without filtering the measurement results over multiple subcarriers/PRBs. The filtering, which is used to suppress interference and noise, often cannot be applied over multiple subcarriers/PRBs where the channel response after beamforming is not contiguous.

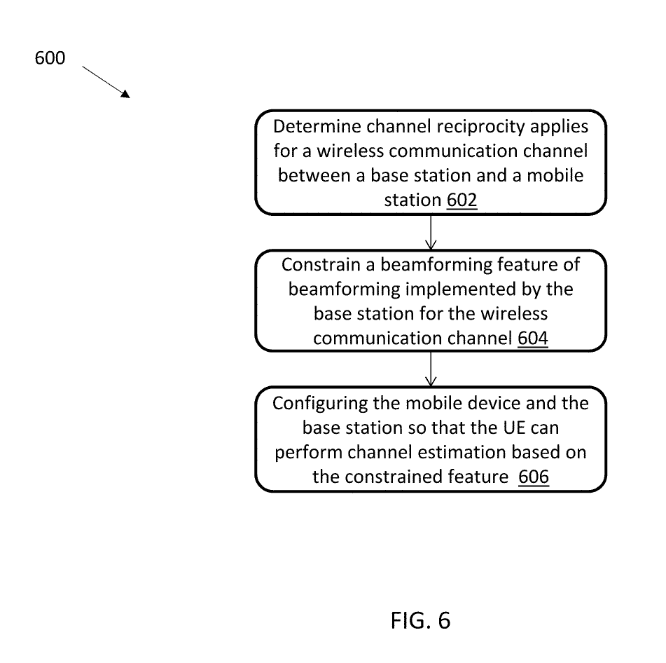

The inventors have developed techniques for providing CSI feedback with channel reciprocity (e.g., when partial or full channel reciprocity is available). Such techniques can provide for channel estimation in wireless communication systems that use beamforming. FIG. 6 shows an exemplary method 600 for facilitating reciprocity-based channel estimation, according to some embodiments. At step 602, the system determines that channel reciprocity applies for a wireless communication channel between a base station and a mobile station. At step 604, the system constrains a beamforming feature of the beamforming that is implemented by the base station for the wireless communication channel. At step 606, the system configures the mobile device (e.g., UE) and the base station so that the UE can perform channel estimation based on the constrained feature.

Referring to steps 604 and 606, for example, the disclosed techniques can be used to restrict the precoder (e.g., rather than allowing the precoder to change along the frequency domain for each PRB/subband). The UE can therefore use a contiguous channel for purposes of channel estimation. In some embodiments, the techniques can be used to configure the UE to determine how large of a bandwidth it can assume the channel is continuous. For example, boundary assumptions can be included so that the UE knows that the beam direction for the precoder is the same for a predetermined unit, such as several resource blocks, subcarriers, frequency bands, and/or the like. The boundary assumptions can be signaled to the UE, e.g., so that the UE can leverage the assumption for channel estimation.

Referring further to steps 604 and 606, reporting modes can be used with feedback components that are suitable when where full and/or partial channel reciprocity is available and beamformed CSI-RS are used. For example, when channel reciprocity is available, a BS (e.g., a gNB) can be configured to use a particular precoder on a particular port. For example, the BS can be configured to precode the first antenna port using a (e.g., best) singular-vector for each subcarrier. The first port may be used to transmit beamformed CSI-RS. By configuring a BS to assign a precoder on a particular port, feedback information can be reduced. For example, it may not be necessary to send feedback information for a particular port-selection, a strongest beam index, and/or the like. Therefore, the techniques can reduce feedback overhead, which can also be used to signal additional information to further improve existing beamforming techniques. For example, as discussed further herein, a precoding bundling assumption on beamformed CSI-RS can be signaled to the UE. As another example, the techniques can provide better flexibility for beamforming. For example, as also discussed further herein, the techniques can provide better flexibility for the network to assign precoders for beamformed CSI-RS ports.

As a non-limiting example, different types of CSI feedback may be used in wireless communication systems. For example, NR defines two types of CSI feedback, Type I and Type II. Type II CSI feedback, which is based on a linear combination of selected beam vectors, can include a number of components. One component is beam selection. Beam selection can include the selection of L beams for linear combination (LC). Each beam can be associated with two LC coefficients for two polarization directions, and each coefficient may consist of amplitude part and phase part. Another component can be an indication of the strongest coefficient (e.g., one out of 2L candidates). A further component can be a linear combination of coefficients for the rest of the coefficients (e.g., 2L−1, since one candidate is indicated as the strongest coefficient). Some wireless protocols specify aspects of CSI operation. For example, details of CSI feedback for Type I and Type II have been discussed for 5G NR. For Type II, for example, for a single panel (SP) case, NR supports Type II Category 1 CSI for rank 1 and 2. PMI is used for Spatial Channel Information feedback. The PMI codebook assumes the following precoder structure:

$$For rank 1 \text{:} W = [ \begin{matrix}{\tilde{w}}_{0 , 0} \\ {\tilde{w}}_{1 , 0}\end{matrix} ] = {W}_{1} {W}_{2} , W is normalized to 1$$

$$For rank 2 \text{:} W = [ \begin{matrix}{\tilde{w}}_{0 , 0} & {\tilde{w}}_{0 , 1} \\ {\tilde{w}}_{1 , 0} & {\tilde{w}}_{1 , 1}\end{matrix} ] = {W}_{1} {W}_{2} , \\ columns of W are normalized to \frac{1}{\sqrt{2}} .$$

For rank 1 and 2, \tilde{w}_{r,l}=Σᵢ₌₀^{L-1}bₖ [symbol] (i)ₖ_{₍ᵢ₎}·p_{r,l,i}^{(WB)}·p_{r,l,i}^{(SB)}·c_{r,l,i}, where the value of L is configurable such that L∈{2,3,4}, bₖ [symbol] ₖ [symbol] is an oversampled 2D discrete Fourier transform (DFT) beam, r=0,1 (polarization), l=0,1 (layer), p_{r,l,i}^{(WB)} is the wideband (WB) beam amplitude scaling factor for beam i and on polarization r and layer l, p_{r,l,i}^{(SB)} is the subband (SB) beam amplitude scaling factor for beam i and on polarization r and layer l, and is the beam combining coefficient (phase) for beam i and on polarization r and layer l. The techniques can be configurable between QPSK (2 bits) and 8PSK (3 bits). The amplitude scaling mode can be configurable between WB+SB (e.g., with unequal bit allocation) and WB-only.

For each polarization, e.g., where r is either 0 or 1, there can be L weighting coefficients associated with bₖ [symbol] ₍ᵢ₎ₖ [symbol] ₍ᵢ₎ for i=0, . . . , L−1. Each weighting coefficient can be the product of p_{r,l,i}^{(WB)} p_{r,l,i}^{(SB)} and c_{r,l,i}, which denote the WB amplitude scaling factor, the SB amplitude scaling factor, and the SB phase factor, respectively. The UE may also need to report which one of the 2L coefficients is the strongest coefficient as part of the wideband feedback.

As another example, Type II Category 3 CSI feedback is a type of hybrid CSI feedback. For example, Type II Category 3 CSI feedback can be based on LTE-Class-B-type-like CSI feedback (e.g. based on port selection/combination codebook) and/or based on the Type II Category 1 linear combination codebook. Hybrid CSI can be an effective way to reduce CSI-RS overhead for CSI acquisition, such as for cases with a large number of transmission antenna elements. Hybrid CSI can consist of two stages of CSI acquisition. The CSI acquired from the first stage can be utilized to precode CSI-RS resources so that the UE can feedback the second stage CSI based on measurements of the precoded/beamformed CSI-RS resources. As another example, for the codebook for beamformed CSI-RS, the system can be configured to reuse the amplitude and co-phasing from Type II SP with W₁ configured to enable port subset selection.

As mentioned above, for reciprocity-based CSI acquisition, the precoder (e.g., on CSI-RS in each PRB/subband) can vary, and/or the precoded port (e.g., and associated index) with the best strength may vary from subband to subband. For example, in FDD mode, W1 and the indication of strongest coefficient are WB reported. Then the BS may precode CSI-RS by following this WB W1, and the UE computes the W2 feedback based on its measurement on the precoded/beamformed CSI-RS resource. Since W1 is WB reported, it can be reasonable to let the indication of strongest coefficient also be WB reported. However, in some scenarios where full or partial channel reciprocity could be utilized (e.g., in TDD mode), the precoder for beamformed CSI-RS does not need to be the same over the whole band, and it can be acquired based on the measurement of SRS. With finer granularity than that of CSI feedback in frequency domain, the BS may have enough information from the SRS measurement to be able to determine which spatial direction matches the channel between the BS and its served UEs without UE feedback. The base-station may have the flexibility to allocate unequal power on the beamformed CSI-RS ports for each PRB. As a result, the indication of the WB strongest coefficient can become less meaningful because the BS has sufficient information from the measurement of SRS to precode CSI-RS for each PRB so that a particular beamformed CSI-RS port can be always the best port over the whole band. The WB scaling factor p_{r,l,i}^{(WB)} may also not be beneficial in such scenarios with channel reciprocity because it is likely that p_{r,l,i}^{(WB)} may act like port-selection such that it is set to either one or zero if the BS already allocates power on the beamformed CSI-RS ports for each PRB properly based on the SRS measurement. Such a port-selection like operation can be functionally replaced by rank indicator (RI), which indicates the number of best CSI-RS ports are preferred by the UE, so p_{r,l,i}^{(WB)} may not need to additionally be used or reported. For example, if a UE reports RI=2, it can imply the first two CSI-RS ports are preferred and each port is supposed to be used to transmit one layer. Then p_{r,l,i}^{(WB)} can be ignored and feedback of SB amplitude scaling factor and SB phase factor can be utilized to fine tune the precoder to be used for data transmission later.

As mentioned above in conjunction with steps 604 and 606, the techniques can be used to reduce CSI reporting overhead. For example, the techniques can be used to remove components to reduce the CSI reporting. For example, in some embodiments, the techniques can configure the system to allow CSI reporting for Type II CSI feedback with no WB components. The CSI reporting overhead can be reduced, e.g., including eliminating the need to report beam selection, an indication of the strongest beam/coefficient, and/or other aspects related to WB components. In some embodiments, the techniques can configure the system to not report amplitude. For example, the system can allow CSI reporting for Type II CSI feedback with SB-phase only. As another example, an additional mode for amplitude reporting can be included that does not report amplitude.

In some embodiments, the techniques can allow a UE to choose the beam(s) for sub-bands. For example, the system can configure a UE with a CSI report setting to allow CSI reporting for Type II CSI feedback with SB beam selection so that the UE can choose different beams at different subbands. The CSI report setting may indicate whether the number of selected beams at different sub-bands should be the same or not. The number of selected beams can be configured by the network via high-layer signaling. As another example, the system may configure a UE with a CSI report setting that requests the UE to report the number of selected beams as a part of the CSI report.

As another example, the techniques can configure a CSI report setting to use a SB-phase only, to use SB-ampltude+SB-phase CSI reporting for Type II CSI feedback, and/or the like. This can be done, for example, when (e.g., or assuming) that all beamformed CSI-RS ports are used. Such techniques can therefore be used to reduce and/or eliminate the need to report information related to beam selection. In some embodiments, the UE can be configured to take the first beamformed CSI-RS port as a reference, and to report the SB phase combining coefficients corresponding to the rest of the beamformed CSI-RS ports. In such implementations, there may be little impact on existing messaging flows and/or structures, e.g., such as just allowing reporting with no amplitude information. Such reporting techniques or reporting formats can be indicated in, for example, the CSI report settings.

In some embodiments, the techniques can configure codebooks for port configurations without codebooks. The techniques can configure the system to use existing codebooks for non-precoded reference signals for beamformed reference signals. For example, existing beamforming techniques may only define codebooks for beamformed CSI-RS for more than two ports (e.g., for four or more ports). Such existing techniques may also perform WB port selection, may reuse amplitude and co-phasing from Type II SP with W₁ configured to enable port subset selection, may provide SB phase combining coefficients, WB or WB+SB amplitude scaling, and/or the like. The techniques discussed herein can be used to configure the UE to use certain codebooks for certain beamformed antenna configurations. For example, the UE can be configured (along with the setting of each CSI report) to use a codebook for two port non-precoded CSI-RS for two port beamformed CSI-RS.

For example, if there are only two beamformed CSI-RS ports, existing techniques for Type I single panel can be followed. For 2 ports, NR supports the following Type I codebook, which was designed for non-beamformed CSI-RS ports:

$$W ∈ \{ \frac{1}{\sqrt{2}} [ \begin{matrix}1 \\ {e}^{j \frac{π n}{z}}\end{matrix} ] , n = 0 , 1 , 2 , 3 \} for rank \text{-} 1 ; and$$

$$\{ \frac{1}{2} [ \begin{matrix}1 & 1 \\ {j}^{n} & - {j}^{n}\end{matrix} ] , n = 0 , 1 \} for rank \text{-} 2.$$

For implementations with more beamformed CSI-RS ports, it may be desirable to use beam selection, e.g., to reduce the number of coefficients for CSI feedback. As noted above, due to the nature of channel reciprocity, the precoder on CSI-RS in each PRB/subband could vary, the indexes for good beams may be different from subband to subband, and/or the like. Thus SB-based beam selection may still be used due to such variations. The beam selection can be configured to be per sub-band based, and a single rank indication can be used for all sub-bands. The number of selected beams at different sub-bands can be the same, and it can be either configured by network or reported by the UE.

In some embodiments, as mentioned above in conjunction with steps 604 and 606, the techniques can configure the system to signal information related to a precoding bundling assumption made on beamformed CSI-RS ports to UE. For example, the concept of precoding bundling can imply the precoder is the same over a number of PRBs. LTE has adopted precoding bundling. For example, a UE may be configured to use assumptions for precoding bundling when the UE performs channel estimation on beamformed CSI-RS ports. If per PRB or per SB based precoding is allowed for beamformed CSI-RS, the UE may need to know the precoding bundling information indicating the number of PRBs where the same precoder is applied on beamformed CSI-RS, instead of assuming the precoder on the beamformed CSI-RS is the same over the whole band. Otherwise a UE may have trouble filtering the estimated channel frequency response from beamformed CSI-RS along the frequency-domain. For example, a UE typically needs to perform some filtering for channel estimation. Without a precoding assumption, the UE may not be able of determine how to perform filtering, which can affect channel estimation.

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A computerized method for performing channel estimation of a wireless communication channel, the method comprising:
constraining beamforming implemented by the base station for the wireless communication channel, comprising restricting the base station to use a set of precoders for a set of frequency sets, wherein the base station is restricted to use each precoder in the set of precoders for one associated frequency set from the set of frequency sets to perform beamforming; and
transmitting to the mobile device data indicative of the constrained beamforming implemented by the base station.

2. The method of claim 1, wherein transmitting to the mobile device data indicative of the constrained beamforming implemented by the base station comprises configuring the mobile device to assume that one precoder from the set of precoders is applied by the base station over its one associated frequency set.

3. The method of claim 1, wherein restricting the base station to use each precoder over an associated frequency set comprises restricting the base station to use a precoder for a predetermined set of units in frequency domain.

4. The method of claim 3, wherein the predetermined set of units comprises a unit selected from the group consisting of a set of adjacent resource blocks, a set of adjacent subcarriers, and a set of adjacent frequency bands.

5. A base station comprising a processor in communication with memory, the processor being configured to execute instructions stored in the memory that cause the processor to:
configure a channel estimation process between a mobile device and the base station such that the mobile device estimates a set of channel characteristics for a downlink direction of the wireless communication channel corresponding to a first set of antennas, wherein the mobile device is configured to use the first set of antennas to transmit signals and a second set of antennas to receive signals, wherein the first set of antennas is part of the second set of antennas;
estimate a set of channel characteristics for an uplink direction of the wireless communication channel based on signals transmitted by the mobile device over the first set of antennas; and
receive a report associated with the set of channel characteristics for the downlink direction of the wireless communication channel from the mobile device, wherein the mobile device generates the report based on the estimated set of channel characteristics for the downlink direction of the wireless communication channel corresponding to the first set of antennas.

6. The base station of claim 5, wherein the report comprises an estimated channel quality, an estimated noise quality, or both.

7. The base station of claim 5, wherein:
estimating the set of channel characteristics of the uplink direction comprises estimating the uplink direction based on sounding reference signals (SRSs) sent by the mobile device to the base station over the first set of antennas; and
receiving the report associated with the set of channel characteristics for the downlink direction of the wireless communication channel comprises receiving channel state information (CSI) generated by the mobile device assuming the first set of antennas are receive antennas.

8. The base station of claim 5, wherein configuring the channel estimation process between the base station and the mobile device comprises:
signaling to the mobile device to configure the channel estimation process;
storing a predetermined rule that configures the channel estimation process; or both.

9. A mobile device, comprising:
a plurality of antennas, wherein a first set of the plurality of antennas are used to transmit signals and a second set of the plurality of antennas are used to receive signals, wherein the first set of the plurality of antennas is part of the second set of the plurality of antennas; and
a processor in communication with memory, the processor being configured to execute instructions stored in the memory that cause the processor to:
transmit signals to a base station over the first set of the plurality of antennas;
estimate a set of channel characteristics for a downlink direction of the wireless communication channel from the base station; and
generate a report associated with a set of channel characteristics for a downlink direction of the wireless communication channel based on the estimated set of channel characteristics for the downlink direction of the wireless communication channel corresponding to the first set of the plurality of antennas.

10. The mobile device of claim 9, wherein the report comprises an estimated channel quality, an estimated noise quality, or both.

11. The mobile device of claim 9, wherein:
transmitting the signals to the base station over the first set of the plurality of antennas comprises transmitting sounding reference signals (SRSs) to the base station over the first set of antennas; and
generating the report comprises generating channel state information (CSI) based on the first set of antennas being receive antennas.

12. The mobile device of claim 9, the processor being further configured to execute instructions stored in the memory that cause the processor to:
receive a signaling from the base station to configure the channel estimation process;
access a predetermined rule that configures the channel estimation process; or both.

13. A computerized method executed by a base station, comprising:
configuring a channel estimation process between a mobile device and the base station such that the mobile device estimates a set of channel characteristics for a downlink direction of the wireless communication channel corresponding to a first set of antennas, wherein the mobile device is configured to use the first set of antennas to transmit signals and a second set of antennas to receive signals, wherein the first set of antennas is part of the second set of antennas;
estimating a set of channel characteristics for an uplink direction of the wireless communication channel based on signals transmitted by the mobile device over the first set of antennas; and
receiving a report associated with the set of channel characteristics for the downlink direction of the wireless communication channel from the mobile device, wherein the mobile device generates the report based on the estimated set of channel characteristics for the downlink direction of the wireless communication channel corresponding to the first set of antennas.

14. The method of claim 13, wherein:
estimating the set of channel characteristics of the uplink direction comprises estimating the uplink direction based on sounding reference signals (SRSs) sent by the mobile device to the base station over the first set of antennas; and
receiving the report associated with the set of channel characteristics for the downlink direction of the wireless communication channel comprises receiving channel state information (CSI) generated by the mobile device assuming the first set of antennas are receive antennas.

15. A computerized method for a mobile device, comprising:
transmitting signals to a base station over a first set of a plurality of antennas, wherein the first set of the plurality of antennas are used to transmit signals and a second set of the plurality of antennas are used to receive signals, wherein the first set of the plurality of antennas is part of the second set of the plurality of antennas;
estimating a set of channel characteristics for an downlink direction of the wireless communication channel, based on the signals received over the second set of the plurality of antennas; and
generating a report associated with a set of channel characteristics for a downlink direction of the wireless communication channel based on the estimated set of channel characteristics for the downlink direction of the wireless communication channel corresponding to the first set of the plurality of antennas.

16. The method of claim 15, wherein:
transmitting the signals to the base station over the first set of the plurality of antennas comprises transmitting sounding reference signals (SRSs) to the base station over the first set of antennas; and
generating the report comprises generating channel state information (CSI) based on the first set of antennas being receive antennas.

17. The method of claim 15, further comprising:
receiving a signaling from the base station to configure the channel estimation process;
accessing a predetermined rule that configures the channel estimation process; or both.

18. A mobile device configured to perform channel estimation of a wireless communication channel between the mobile device and the base station, the mobile device comprising:
a transceiver comprising a set of antennas; and
a processor in communication with memory and the transceiver, the processor being configured to execute instructions stored in the memory that cause the processor to:
receive a signal indicative of a constraining beamforming implemented by the base station for the wireless communication channel, the signal indicative of the base station being restricted to use a set of precoders for a set of frequency sets, wherein the base station is restricted to use each precoder in the set of precoders for one associated frequency set from the set of frequency sets to perform beamforming.

19. The mobile device of claim 18, wherein the processor is further configured to perform channel estimation using one precoder from the set of precoders for a predetermined set of units in frequency domain.

20. The mobile device of claim 19, wherein the predetermined set of units comprises a unit selected from the group consisting of a set of adjacent resource blocks, a set of adjacent subcarriers, and a set of adjacent frequency bands.
